(19) United States
(12) Patent Application Publication
(10) Pub. No.: US 2004/0217971 A1
(43) Pub. Date: Nov. 4, 2004

(54) Recording medium having a data structure for managing reproduction of graphic data and methods and apparatuses of recording and reproducing

(76) Inventors: Hyung Sun Kim, Seoul (KR); Jeong Hye Yang, Jejoo-si (KR); Kang Soo Seo, Dongan-gu (KR); Byung Jin Kim, Bundang-gu (KR)

Correspondence Address: HARNESS, DICKEY & PIERCE, P.L.C., P.O. BOX 8910, RESTON, VA, 20195, US

(21) Appl. No.: 10/831,171

(22) Filed: Apr. 26, 2004

(30) Foreign Application Priority Data
Apr. 29, 2003 (KR) 10-2003-027274

(51) Int. Cl. G06T 11/20

(52) U.S. Cl. 345/589; 345/601

(57) ABSTRACT

In the data structure for managing reproduction of graphic data, a graphic information area of the recording medium includes at least one display information segment and at least one color information segment. Each display information segment provides information for an entire display and not just one region of a display. Each display information segment includes a color information family identifier identifying a family of color information, and the color information segment provides color information belonging to the identified family of color information.

### FOREIGN PRIORITY

The present invention claims priority under 35 U.S.C. 119 on Korean Application No. 10-2003-027274 filed Apr. 29, 2003; the contents of which are incorporated by reference in their entirety.

### BACKGROUND OF THE INVENTION

1. Field of the Invention

The present invention relates a method for managing and reproducing graphic data of a high-density optical disc.

2. Description of the Related Art

Recently, optical discs like DVDs (Digital Versatile Discs) as well as optical disc apparatuses like DVD recorders and DVD players for recording and reproducing data to and from such optical discs have been actively developed and commercialized. These optical discs are capable of storing large amounts of high-resolution video data and high-fidelity audio data.

Generally, a DVD stores main video data and graphic data sometimes referred to as subtitle data. Generally, subtitle data is thought of as text or caption data that may be represented as a bit-map image. However, because this type of subtitle data is image data, some standards such as ETSI EN 300 743 V1.2.1 of the European Video Broadcasting Standard define subtitle data as textual and/or graphical information to provide subtitle or graphs. In this disclosure, the term graphic data or graphic information will be used interchangeably with the term subtitle data to refer to textual and/or graphical information. In a DVD, the subtitle data, such as captions or a logo, is recorded in a format of image data and is synthesized with the main video data when reproduced. In other words, when reproducing the DVD, an optical disc reproduction apparatus like a DVD player reads the subtitle image data together with the main video data from the DVD and outputs them to an external display device like a television receiver so as to produce and display a synthesized picture.

Accordingly, a user can see the reproduced main video data, like picture images, and the subtitle data, like captions or a logo, at the same time via the external display device.

More recently, a high-density optical disc like a BD-ROM having a higher recording density than a conventional DVD has been proposed, and debates on the standardization of such a newly proposed high-density optical disc are taking place in the industry. For example, a method for recording and managing graphic subtitle data of a BD-ROM in a format of image data, like bit map (BMP) data, and reproduction control information thereof has been recommended.

However, there has not yet been provided an adequate data structure or methods for managing the reproduction of the subtitle image data recorded on a BD-ROM. In order to expedite commercialization of a newly proposed high-density optical disc like a BD-ROM, not only a recording medium data structure and method for recording the data structure, but also an effective method for reproducing the subtitle data are required.

### SUMMARY OF THE INVENTION

The recording medium according to the present invention includes a data structure for managing reproduction of graphic data.

In one embodiment, the recording medium includes a graphic information area including at least one graphic information segment and at least one object data segment. Each object data segment provides data for reproducing at least a portion of a graphic image object. Each graphic information segment includes an object identifier and an object cropping flag. The object identifier identifies the graphic image object, and the object cropping flag indicates whether the graphic information segment includes cropping information for the identified graphic image object.

In another embodiment, the recording medium has a graphic information area including at least one display information segment and at least one color information segment. Each display information segment provides information for an entire display and not just one region of a display. Each display information segment includes a color information family identifier identifying a family of color information, and the color information segment provides color information belonging to the identified family of color information.

In this embodiment, the graphic information area may also include at least one object data segment providing data for reproducing at least a portion of a graphic image object. Here, the display information segment includes an object identifier identifying the graphic image object.

The present invention further provides apparatuses and methods for recording and reproducing the data structure according to the present invention, and recording and reproducing data streams according to the present invention.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates an example of a screen, in which a plurality of objects of graphic data also called subtitle data are displayed in a single page according to an embodiment of the present invention;

FIG. 2 illustrates a hierarchical page structure according to one example embodiment of the present invention;

FIG. 3 illustrates an example embodiment of the data structure of a page composition segment recorded on the high-density recording medium according to the present invention;

FIG. 4 illustrates an example embodiment of the data structure of an object data segment recorded on the high-density recording medium according to the present invention;

FIG. 5 illustrates an example embodiment of the data structure for a color lookup table definition segment recorded on a high-density recording medium according to the present invention;

FIG. 6 illustrates an embodiment of an optical disc apparatus to which a method for reproducing subtitle data of a high-density optical disc according to the present invention is applicable; and

FIG. 7 illustrates a schematic diagram of an embodiment of an optical disk recording and reproducing apparatus according to the present invention.

### DETAILED DESCRIPTION OF THE PREFERRED EMBODIMENT

A high-density recording medium such as a BD-ROM can store image data of a format like a bit map (BMP) format as subtitle data (e.g., captions or a logo). In this disclosure, the term graphic data or graphic information will be used interchangeably with the term subtitle data to refer to textual and/or graphical information. In a DVD, the subtitle data, such as captions or a logo, is recorded in a format of image data and is synthesized with the main video data when reproduced. In other words, when reproducing the DVD, an optical disc reproduction apparatus like a DVD player reads the subtitle image data together with the main video data from the DVD and outputs them to an external display device like a television receiver so as to produce and display a synthesized picture.

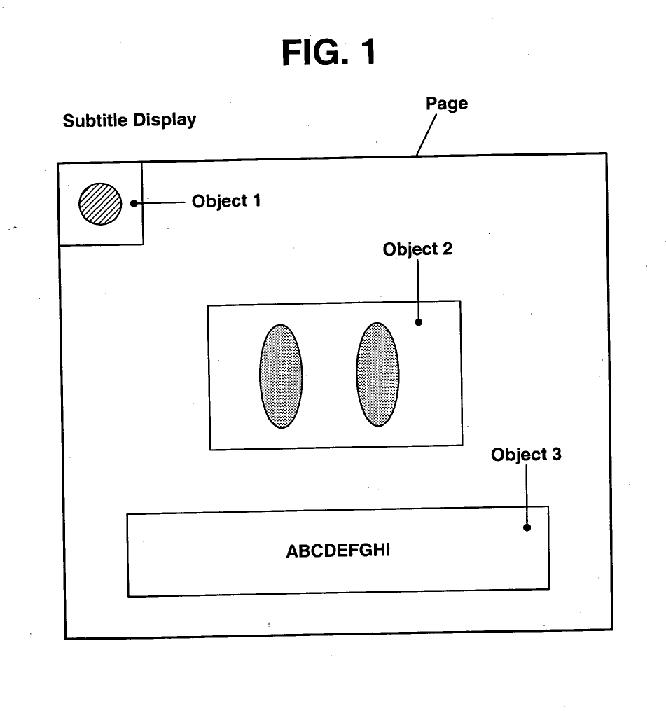

FIG. 1 illustrates an example of a screen, in which a plurality of objects of graphic data also called subtitle data are displayed in a single page according to an embodiment of the present invention. As shown, various types of image data or subtitle data, such as caption or logo data of a BMP format, may be reproduced and displayed in the same display screen (i.e. in the same single page) as different objects. For example, FIG. 1 shows object 1, object 2, and object 3. As will be described in detail below, each of the objects and the page are recorded and managed as a hierarchical page structure so that a plurality of objects can be included and managed in a single page.

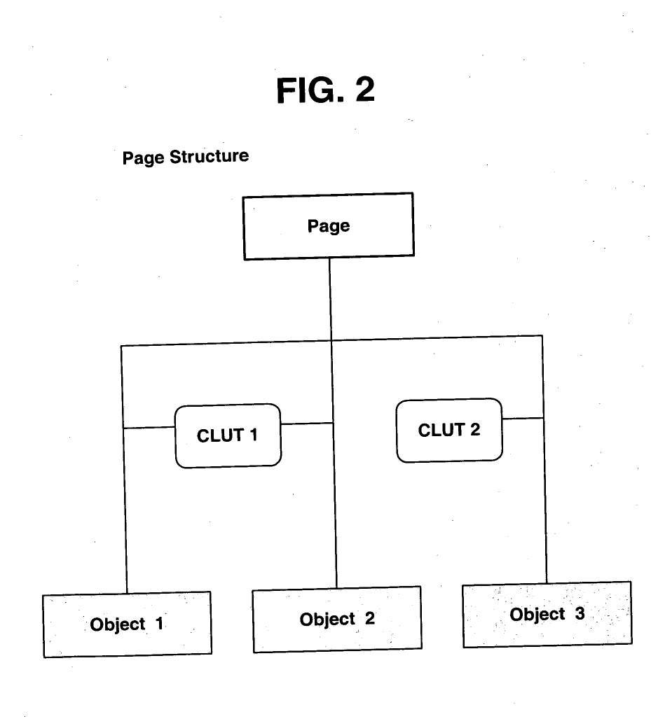

FIG. 2 illustrates a hierarchical page structure according to one example embodiment of the present invention. As shown, the objects are managed as a single page. The page structure further includes and manages color lookup tables CLUT 1 and CLUT 2 for controlling reproduction of color, brightness, and transparency of each object image. Each of the color lookup tables may be linked to only one object image or to a plurality of object images. Further, a global color lookup table commonly linked to a plurality of pages may be used.

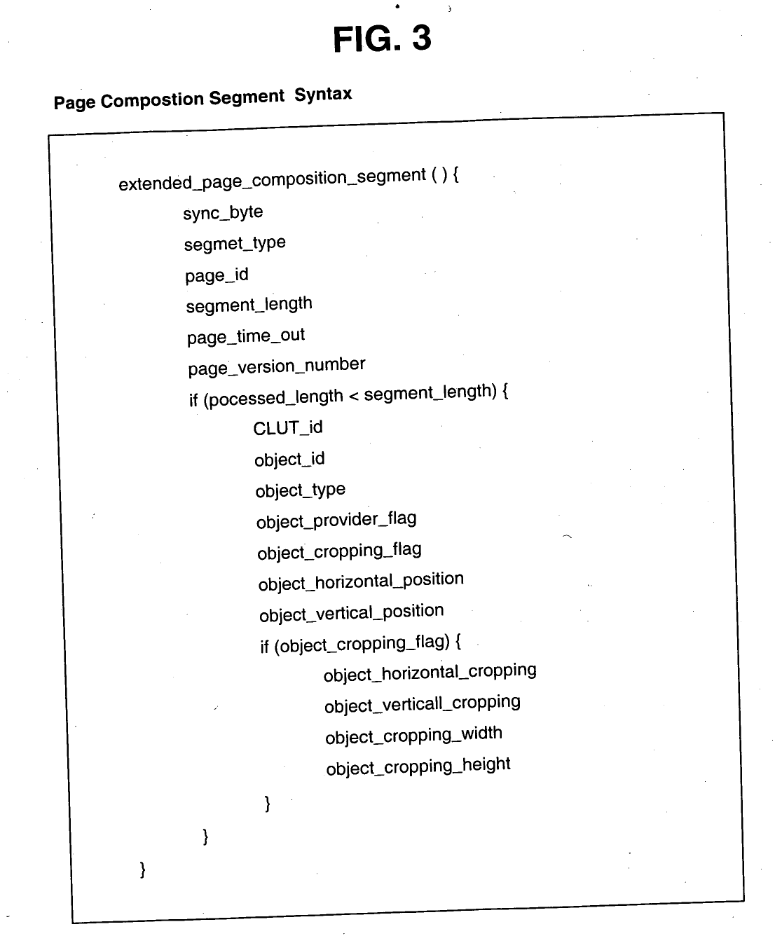

The object images and reproduction control information thereof may be separately recorded in and managed by a page composition segment (PCS), an object data segment (ODS), and a color lookup table definition segment (CDS), as shown in FIGS. 3 to 5, respectively, and described in detail below.

FIG. 3 illustrates an example embodiment of the data structure of a page composition segment recorded on the high-density recording medium according to the present invention. As shown, the page composition segment may include information regarding a sync byte, a segment type, page identification (ID), a segment length, page time out, and a page version number. The sync byte is a well-known field containing a value used to verify synchronization. The segment type information indicates that the corresponding segment is a page composition segment, and the page ID information indicates that the corresponding page is a subtitle page. For example, the page ID may indicate the subtitle page serves a particular language like Korean or English. The segment length indicates the length of the segment following the page version number field. The page time out information is the information for deleting buffering data of the corresponding page from a buffer. The page version number indicates the version of this PCs.

The page composition segment may further include information regarding color lookup table (CLUT) ID, object ID, an object type, an object provider flag, an object cropping flag, and object horizontal/vertical positions.

The CLUT ID identifies a family of CLUTs associated with this PCS. The object ID identifies an object to be shown on the page (i.e., display screen). The object type indicates the type (e.g., bitmap, character, character string, etc.) of the object. The object provider flag indicates how the object identified by the object ID is provided; for example, provided in a subtitle data stream. The object cropping flag indicates whether the PCS includes cropping information for defining an area cropping the object identified by the object ID. For example, in a case where the object cropping flag information is set as ‘1’, the object cropping flag information may include object horizontal/vertical cropping data and object cropping width/height data. The object horizontal/vertical cropping data and the object cropping width/length data are recorded for partially displaying an object image. Specifically, the object horizontal/vertical cropping information specify the position of a cropping rectangle (the cropping area) having the dimensions provided by the object cropping width/length. Only that much of the object lying within the cropping rectangle will be displayed.

The PCS also includes object horizontal/vertical position information, which indicates the position of the object identified by the object ID on the display screen.

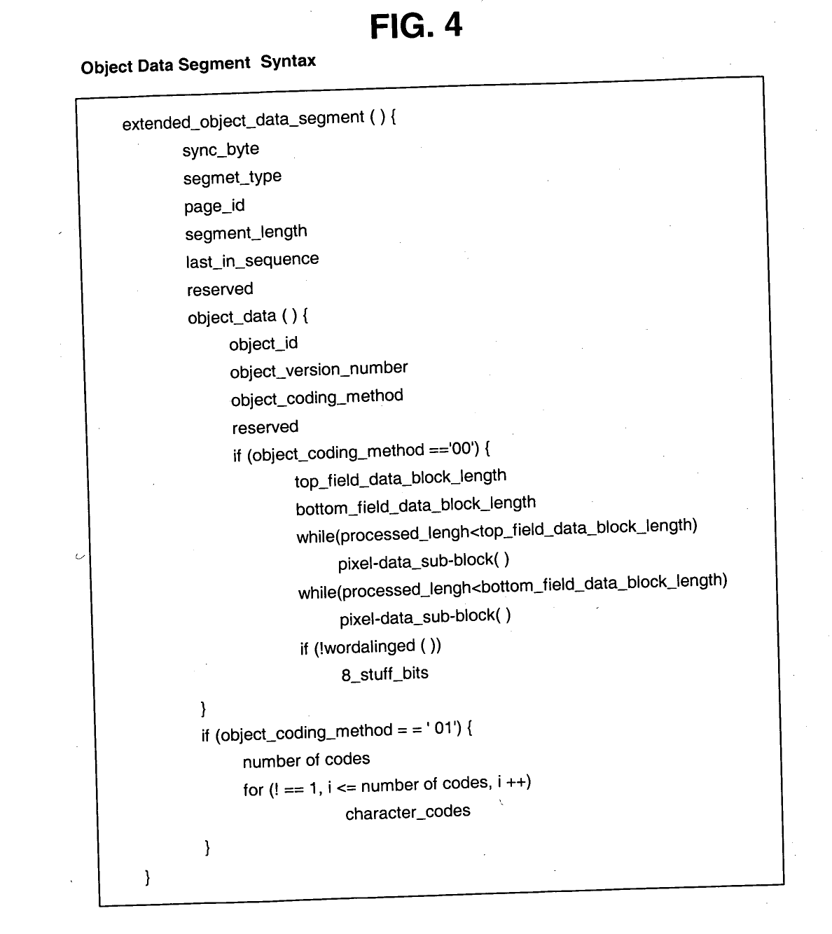

Next, an example embodiment of the data structure of the object data segment will be described with respect to FIG. 4. As shown in FIG. 4, the object data segment may include information regarding a sync byte, a segment type, page ID, a segment length, and a last-in sequence. The sync byte provides a value used to verify synchronization. The segment type information indicates that the segment is an object data segment and the page ID information indicates the page to which the corresponding segment belongs. The segment length indicates the length of the segment following the last-in sequence field. The last-in sequence information indicates whether this is a last ODS needed to reproduce the graphic image object for which the ODS provides graphic image data. As will be appreciated, it may take more than one ODS's worth of graphic image data to form the graphic image object.

Further, the object data segment may include information regarding object ID, an object version number, and an object coding method. The object ID identifies the graphic image object. This object ID will be the same as the object ID in the PCS managing display of the identified graphic image object. The object version number indicates the version of the graphic image data in this ODS. The object coding method indicates the method by which the graphic image object was coded as graphic image data (e.g., bitmap pixels, character codes, etc.).

In one example embodiment, when the object coding method is ‘00’, the ODS includes a top field data block length representing the number of top field data of an object, a bottom field data block length representing the number of bottom field data of the object, and pixel data sub block representing run length coded top field data and bottom field data of the graphic image object. In another example embodiment, the object data is a character code, the object coding method is recorded as ‘01’ and the number of codes and the respective character codes are recorded.

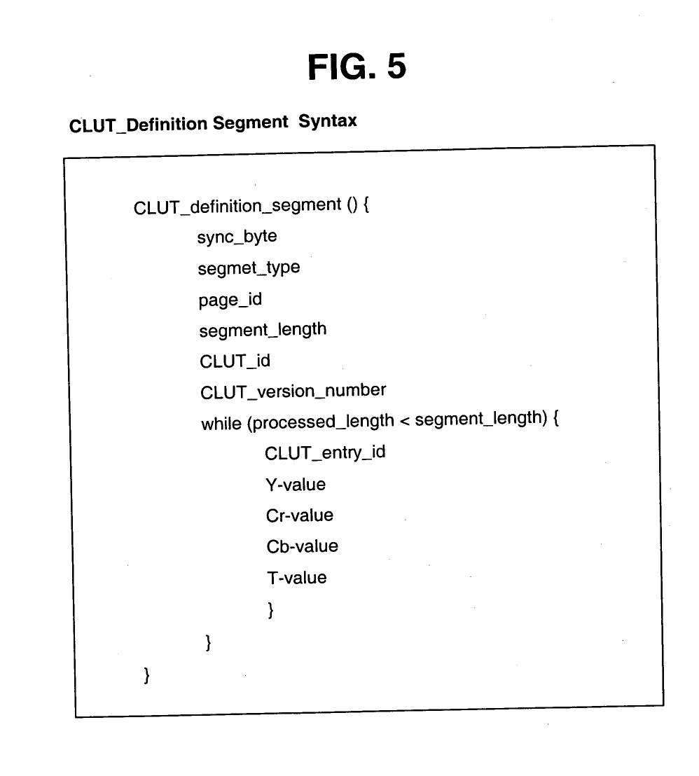

FIG. 5 illustrates an example embodiment of the data structure for a color lookup table definition segment recorded on a high-density recording medium according to the present invention. As shown, the color lookup table definition segment (CDS) may include information regarding a sync byte, a segment type, page ID, a segment length, color lookup table (CLUT) ID, and a color lookup table (CLUT) version number. The sync byte provides a value used to verify synchronization. The segment type information indicates that the segment is a color lookup table definition segment and the page ID information indicates the page to which the corresponding segment belongs. The segment length indicates the length of the segment following the CLUT version number field. The CLUT ID information indicates a family of CLUTs to which the CDS belongs. As will be described in detail below, the CDS provides a single color definition. The family of CLUTs provides a color palette from which to select color definitions. The CLUT version number indicates the version of this CDS.

The color lookup table definition segment may further include information regarding color lookup table entry ID, a brightness value (Y-value), a red color value (Cr-value), a blue color value (Cb-value), and a transparency value (T-value). The CLUT entry ID identifies the entry of this CDS in the family of CLUTs (identified by the CLUT ID) to which this CDS belongs.

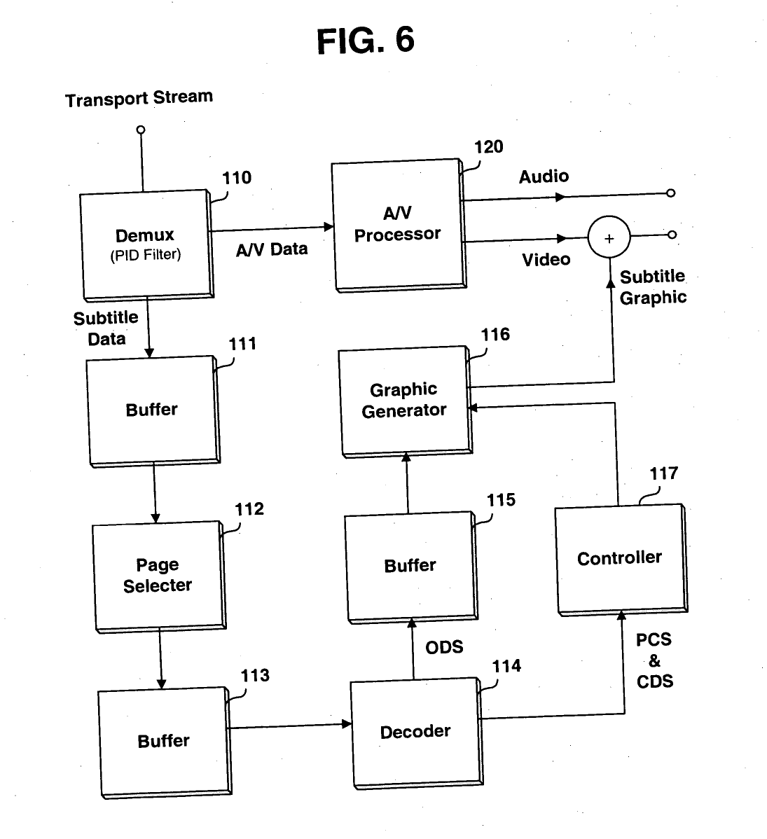

FIG. 6 illustrates an embodiment of an optical disc apparatus to which a method for reproducing subtitle data of a high-density optical disc according to the present invention is applicable. As shown in FIG. 6, the optical disc apparatus includes a demultiplexer (DEMUX) 110, buffers 111, 113, and 115, a page selector 112, a decoder 114, a graphic generator 116, a controller 117, and an A/V processor 120.

The DEMUX 110 separates subtitle or graphic data and A/V data from a data stream, such as a transport stream, read from an optical disc with reference to packet ID (PID) information. The A/V processor 120 performs a series of processes, such as decoding the separated A/V data and outputting the decoded audio and video signals.

The separated subtitle data is temporarily stored in the buffer 111 and is provided to the page selector 112. The page selector 112 selectively outputs particular subtitle data, i.e., the page composition segment (PCS), the object data segment (ODS), and the color look table definition segment (CDS). When the page ID information corresponds to the caption or logo data of a particular language, a user will have selected the desired language and this selection will have been provided to the page selector 112. The page selector 112 selects the PDS, ODS, and CDS having the page ID matching the user's selection.

The selected page composition segment (PCS), the object data segment (ODS), and the color lookup table definition segment (CDS) are temporarily stored in the buffer 113 and are then provided to the decoder 114. The decoder 114 performs a series of decoding processes for decoding the segments. At this time, the image data included in the object data segment (ODS) is temporarily stored in the buffer 115, and is then provided to the graphic generator 116.

On the other hand, the reproduction control information included in the page composition segment (PCS) and the color lookup table definition segment (CDS) are provided to the controller 117. The controller 117 performs a series of control processes for controlling operations of the graphic generator 116 with reference to the reproduction control information.

Accordingly, the graphic generator 116 produces and outputs graphic images of the subtitle corresponding to the reproduction control information included in the page composition segment (PCS) and the color lookup table definition segment (CDS). As shown, the graphic image of the subtitle is displayed as a subtitle image together with main video image reproduced via the A/V processor 120.

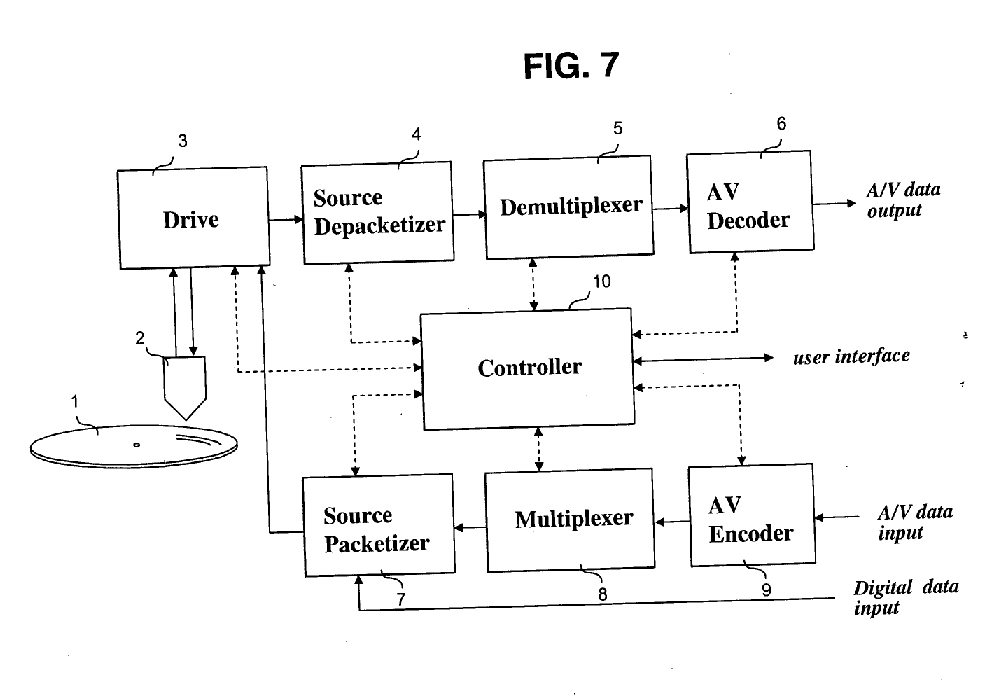

FIG. 7 illustrates a schematic diagram of an embodiment of an optical disk recording and reproducing apparatus according to the present invention. As shown, an AV encoder 9 receives and encodes data (e.g., still image data, audio data, text subtitle data etc.). The AV encoder 9 outputs the encoded data along with coding information and stream attribute information. A multiplexer 8 multiplexes the encoded data based on the coding information and stream attribute information to create, for example, an MPEG-2 transport stream. A source packetizer 7 packetizes the transport packets from the multiplexer 8 into source packets in accordance with the audio/video format of the optical disk. As shown in FIG. 7, the operations of the AV encoder 9, the multiplexer 8 and the source packetizer 7 are controlled by a controller 10. The controller 10 receives user input on the recording operation, and provides control information to AV encoder 9, multiplexer 8 and the source packetizer 7. For example, the controller 10 instructs the AV encoder 9 on the type of encoding to perform, instructs the multiplexer 8 on the transport stream to create, and instructs the source packetizer 7 on the source packet format. The controller 10 further controls a drive 3 to record the output from the source packetizer 7 on the optical disk.

For example, based on information received via the user interface (e.g., instruction set saved on disk, provided over an intranet or internet by a computer system, etc.) the controller 10 controls the drive 3 to record one or more of the data structures of FIGS. 3-5 on the optical disk.

During reproduction, the controller 10 controls the drive 3 to reproduce this data structure. Based on the information contained therein, as well as user input received over the user interface (e.g., control buttons on the recording and reproducing apparatus or a remote associated with the apparatus), the controller 10 controls the drive 3 to reproduce the data from the optical disk.

The reproduced source packets are received by a source depacketizer 4 and converted into a data stream (e.g., an MPEG-2 transport packet stream). A demultiplexer 5 demultiplexes the data stream into encoded data. An AV decoder 6 decodes the encoded data to produce the original data that was feed to the AV encoder 9. During reproduction, the controller 10 controls the operation of the source depacketizer 4, demultiplexer 5 and AV decoder 6. The controller 10 receives user input on the reproducing operation, and provides control information to AV decoder 6, demultiplexer 5 and the source packetizer 4. For example, the controller 10 instructs the AV decoder 9 on the type of decoding to perform, instructs the demultiplexer 5 on the transport stream to demultiplex, and instructs the source depacketizer 4 on the source packet format. As will be appreciated, the logical blocks of this embodiment may be structured in accordance with the physical structure described in detail with respect to FIG. 6.

While FIG. 7 has been described as a recording and reproducing apparatus, it will be understood that only a recording or only a reproducing apparatus may be provided using those portions of FIG. 7 providing the recording or reproducing function.

The data structure for and method for managing subtitle data on a high-density recording medium in accordance with embodiments of the present invention allows effective management of the reproduction of the subtitle data.

As apparent from the above description, the present invention provides methods and apparatuses for recording a data structure on a high density recording medium for managing reproduction of subtitle data.

The above description further provides methods and apparatus for reproducing subtitle data based on the data structure for managing the reproduction of the subtitle data.

While the invention has been disclosed with respect to a limited number of embodiments, those skilled in the art, having the benefit of this disclosure, will appreciate numerous modifications and variations there from. For example, while described with respect to a Blu-ray ROM optical disk in several instances, the present invention is not limited to this standard of optical disk or to optical disks. It is intended that all such modifications and variations fall within the spirit and scope of the invention.

What is claimed is:

1. A recording medium having a data structure for managing reproduction of graphic data, comprising:
a graphic information area including at least one graphic information segment and at least one object data segment, each object data segment providing data for reproducing at least a portion of a graphic image object, each graphic information segment including an object identifier and an object cropping flag, the object identifier identifying the graphic image object, and the object cropping flag indicating whether the graphic information segment includes cropping information for the identified graphic image object.

2. The recording medium of claim 1, wherein when the object cropping flag indicates that the graphic information segment includes cropping information, the object cropping information includes position information for a cropping area.

3. The recording medium of claim 2, wherein when the object cropping flag indicates that the graphic information segment includes cropping information, the object cropping information includes dimension information for the cropping area.

4. The recording medium of claim 1, wherein when the object cropping flag indicates that the graphic information segment includes cropping information, the object cropping information includes dimension information for the cropping area.

5. The recording medium of claim 1, wherein the graphic information segment includes position information for positioning the identified graphic image object.

6. The recording medium of claim 1, wherein each object data segment including data for reproducing the graphic image object identified by the object identifier in the graphic information segment includes the object identifier.

7. The recording medium of claim 6, wherein each object data segment includes a version number indicating a version of the data in the object data segment.

8. The recording medium of claim 6, wherein each object data segment includes a last in sequence indicator indicating whether the object data segment is a last object data segment needed to reproduce the graphic image object identified by the object identifier in the object data segment.

9. The recording medium of claim 1, wherein
the graphic information area includes at least one color information segment, each color information segment providing color information; and
the graphic information segment includes a color information family identifier identifying a family of color information.

10. The recording medium of claim 9, wherein each color information segment including color information for the family of color information identified by the color information family identifier in the graphic information segment includes the color information family identifier.

11. The recording medium of claim 10, wherein each color information segment includes a version number indication a version of the color information in the color information segment.

12. The recording medium of claim 10, wherein each color information segment includes an entry number indicating the entry of the color information in the family of color information identified by the color information family identifier in the color information segment.

13. The recording medium of claim 12, wherein the color information includes luminance and chrominance information.

14. The recording medium of claim 12, wherein the color information segment includes transparency information.

15. A recording medium having a data structure for managing reproduction of graphic data, comprising:
a graphic information area including at least one display information segment and at least one color information segment, each display information segment providing information for an entire display and not just one region of a display, each display information segment including a color information family identifier identifying a family of color information, and the color information segment providing color information belonging to the identified family of color information.

16. The recording medium of claim 15, wherein each color information segment including color information for the family of color information identified by the color information family identifier in the display information segment includes the color information family identifier.

17. The recording medium of claim 16, wherein each color information segment includes a version number indication a version of the color information in the color information segment.

18. The recording medium of claim 16, wherein each color information segment includes an entry number indicating the entry of the color information in the family of color information identified by the color information family identifier in the color information segment.

19. The recording medium of claim 18, wherein the color information includes luminance and chrominance information.

20. The recording medium of claim 18, wherein the color information segment includes transparency information.

21. The recording medium of claim 15, wherein
the graphic information area includes at least one object data segment;
each object data segment providing data for reproducing at least a portion of a graphic image object; and
each display information segment includes an object identifier and an object cropping flag, the object identifier identifying the graphic image object, and the object cropping flag indicating whether the display information segment includes cropping information for the identified graphic image object.

22. The recording medium of claim 21, wherein when the object cropping flag indicates that the display information segment includes cropping information, the object cropping information includes position information for a cropping area.

23. The recording medium of claim 22, wherein when the object cropping flag indicates that the display information segment includes cropping information, the object cropping information includes dimension information for the cropping area.

24. The recording medium of claim 21, wherein when the object cropping flag indicates that the display information segment includes cropping information, the object cropping information includes dimension information for the cropping area.

25. The recording medium of claim 21, wherein the display information segment includes position information for positioning the identified graphic image object.

26. The recording medium of claim 21, wherein each object data segment including data for reproducing the graphic image object identified by the object identifier in the display information segment includes the object identifier.

27. The recording medium of claim 26, wherein each object data segment includes a version number indicating a version of the data in the object data segment.

28. The recording medium of claim 26, wherein each object data segment includes a last in sequence indicator indicating whether the object data segment is a last object data segment needed to reproduce the graphic image object identified by the object identifier in the object data segment.

29. A method of recording a data structure for managing reproduction of a graphic data, comprising:
recording at least one display information segment and at least one color information segment on a recording medium, each display information segment providing information for an entire display and not just one region of a display, each display information segment including a color information family identifier identifying a family of color information, and the color information segment providing color information belonging to the identified family of color information.

30. A method of reproducing a data structure for managing reproduction of a graphic data, comprising:
reproducing at least one display information segment and at least one color information segment from a recording medium, each display information segment providing information for an entire display and not just one region of a display, each display information segment including a color information family identifier identifying a family of color information, and the color information segment providing color information belonging to the identified family of color information.

31. An apparatus for recording a data structure for managing reproduction of a graphic data, comprising:
a driver for driving an optical recording device to record data on the recording medium;
a controller for controlling the driver to record at least one display information segment and at least one color information segment on a recording medium, each display information segment providing information for an entire display and not just one region of a display, each display information segment including a color information family identifier identifying a family of color information, and the color information segment providing color information belonging to the identified family of color information.

32. An apparatus for reproducing a data structure for managing reproduction of a graphic data, comprising:
a driver for driving an optical reproducing device to reproduce data recorded on the recording medium;
a controller for controlling the driver to reproduce at least one display information segment and at least one color information segment from a recording medium, each display information segment providing information for an entire display and not just one region of a display, each display information segment including a color information family identifier identifying a family of color information, and the color information segment providing color information belonging to the identified family of color information.
